(19) United States
(12) Patent Application Publication
(10) Pub. No.: US 2019/0080280 A1
(43) Pub. Date: Mar. 14, 2019

(54) SYSTEMS AND METHODS OF TRACKING OBJECTS IN A RETAIL STORE UTILIZING CHANGES IN READS FROM SETS OF PRODUCT RFID TAGS

(71) Applicant: Walmart Apollo, LLC, Bentonville, AR (US)

(72) Inventors: Jeremy R. Tingler, Bentonville, AR (US); Nicholaus A. Jones, Fayetteville, AR (US); Alvin S. Taulbee, Springdale, AR (US); Todd D. Mattingly, Bentonville, AR (US)

(21) Appl. No.: 16/127,844

(22) Filed: Sep. 11, 2018

Related U.S. Application Data
(60) Provisional application No. 62/556,704, filed on Sep. 11, 2017.

(51) Int. Cl. G06Q 10/08; G06K 7/10

(52) U.S. Cl. CPC G06Q 10/087; G06K 7/10475

(57) ABSTRACT

In some embodiments, systems and methods are provided to track objects at a retail store, comprising: multiple RFID tag readers to detect a set of different RFID tags each associated with a different item; and a tracking control circuit configured to: receive, from RFID tag readers, RFID tag information of each RFID tag of a subset of the RFID tags; obtain and use a first set of rules to evaluate, over time and for each of the subset of RFID tags, the RFID tag information and identify threshold changes from a set of base information, wherein the threshold change at each of the set of RFID tag readers is consistent with an object moving proximate the RFID tag reader and items corresponding to the RFID tags; and track the object along travel areas as a function of timing of the detected changes from the base information.

### CROSS-REFERENCE TO RELATED APPLICATION

This application claims benefit of U.S. Provisional Application No. 62/556,704, filed Sep. 11, 2017, which is incorporated herein by reference in its entirety.

### TECHNICAL FIELD

This invention relates generally to track objects in a retail store.

### BACKGROUND

Retail stores continue to be a primary way in which people purchase products for consumption and use. Customers enter the store and often push carts or carry baskets while collecting products the customer is going to purchase. The products are distributed throughout a sales floor of the retail store and accessible to customers to retrieve. There continues to be a need to provide a positive shopping experience for customers.

### BRIEF DESCRIPTION OF THE DRAWINGS

Disclosed herein are embodiments of systems, apparatuses and methods to track objects through a retail store. This description includes drawings, wherein:

FIG. 1 illustrates a simplified block diagram of an exemplary retail store RFID customer tracking system, in accordance with some embodiments;

FIG. 2 illustrates a simplified overhead view of at least a portion of an exemplary retail store or shopping facility that includes multiple product support devices supporting numerous items of different products available for purchase by customers, in accordance with some embodiments;

FIG. 3 illustrates a simplified plane view of an exemplary set or array of RFID tag readers positioned relative to a portion of an exemplary product support device supporting a subset of items of different types of products, in accordance with some embodiments;

FIG. 4 illustrates a simplified graphical representation of exemplary RSSI and read rates corresponding to an RFID tag over time, in accordance with some embodiments;

FIG. 5 illustrates a simplified flow diagram of an exemplary process of tracking customers and/or other objects through a retail store based on RFID signals, in accordance with some embodiments; and

FIG. 6 illustrates an exemplary system for use in implementing methods, techniques, devices, apparatuses, systems, servers, and sources to track customers and/or other objects through a retail store based on RFID signals, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to autonomously track customers and/or carts at a retail store or retail shopping facility that customers visit to view, select and purchase products. Some shopping facilities position numerous products throughout a sales floor that are to be sold and/or distributed to customers. The facility may be any size or format, and may include products from one or more merchants. For example, a facility may be a single store operated by one merchant, a chain of two or more stores operated by one entity, or may be a collection of stores covering multiple merchants. Some embodiments provide a retail store customer tracking system, comprising: multiple RFID (radio frequency identification) tag readers distributed throughout a retail store, and one or more tracking control circuits communicatively coupled with the multiple RFID tag readers. The RFID tag readers are each configured to detect a set of at least one of multiple different RFID tags that are each associated with one of multiple different items of products offered for sale at the retail store. The tracking control circuit implements code stored on memory and configured to: receive, from a set of RFID tag readers of the multiple RFID tag readers, RFID tag information of each RFID tag of a detected subset of the multiple RFID tags; obtain a first set of rules to identify changes in RFID tag information; use the first set of rules to evaluate, over time and for each of the subset of RFID tags, the RFID tag information and identify over time threshold changes from a set of base information of received RFID signals from the subset of RFID tags being read at each of a set of the RFID tag readers positioned along at least a first travel area within the retail store, wherein the threshold change at each of the set of RFID tag readers is consistent with a first object moving to be positioned proximate the respective RFID tag reader and a subset of the multiple items corresponding to the subset of RFID tags; and track the first object without obtaining an identifier of the first object as the first object moves along at least the first travel area as a function of timing of the detected changes from the base information of the received RFID signals from the subset of RFID tags being read at each of the RFID tag readers of the set of RFID tag readers.

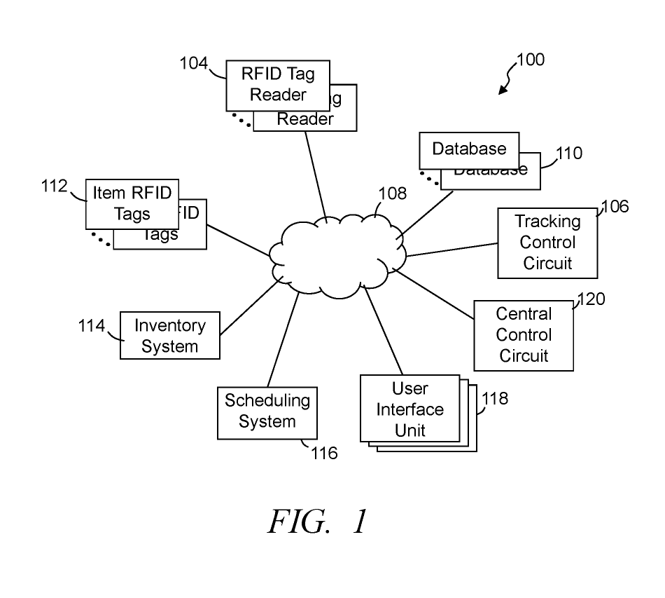

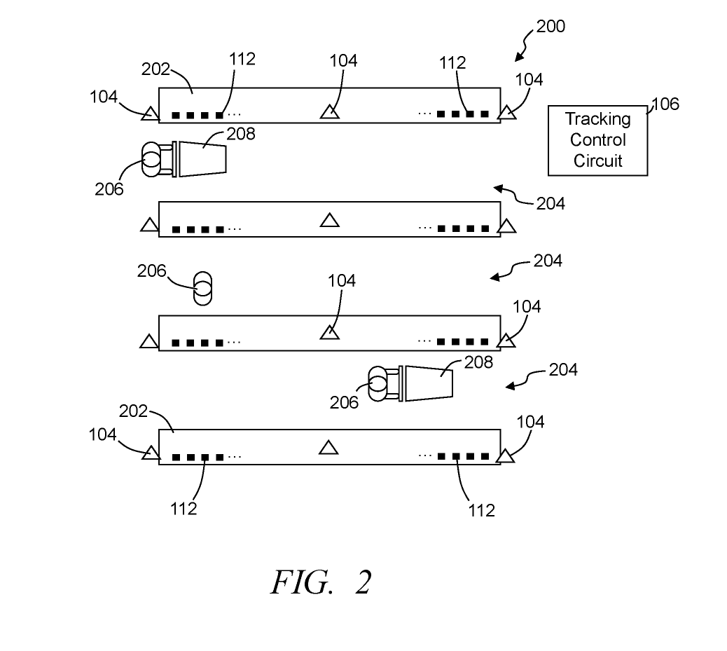

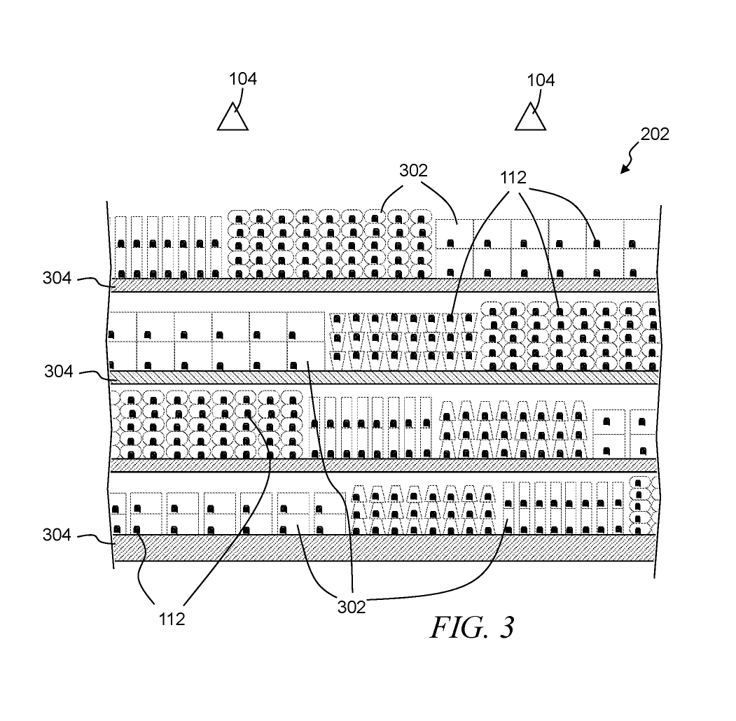

FIG. 1 illustrates a simplified block diagram of an exemplary retail store RFID customer tracking system 100, in accordance with some embodiments. FIG. 2 illustrates a simplified overhead view of at least a portion of an exemplary retail store 200 or shopping facility that includes multiple product support devices 202 supporting numerous items 302 of different products available for purchase by customers, in accordance with some embodiments. FIG. 3 illustrates a simplified plane view of an exemplary set or array of RFID tag readers 104 positioned relative to a portion of an exemplary product support device 202 supporting a subset of items 302 of different types of products, in accordance with some embodiments. Referring to FIGS. 1-3, the customer tracking system 100 includes multiple RFID tag readers 104 that are communicatively coupled to one or more tracking control circuits 106 over one or more communication and/or computer networks 108. The RFID tag readers 104 are distributed through the retail store 200, with at least some of the multiple RFID tag readers being positioned at fixed locations throughout the retail store. In some implementations, the RFID tag readers 104 are distributed to provide one or more arrays each establishing a read grid. The tracking control circuit is 106 further communicatively coupled with one or more databases 110 (e.g., rules database, tag read database, inventory database, worker database, customer database, etc.), which may be maintained in memory within the tracking control circuit 106, memory directly coupled with the tracking control circuit and/or remote memory.

The RFID tag readers 104 are configured to read RFID tags 112 through RFID signals received from the RFID tags affixed to or incorporated into packaging and/or affixed to items being sold from the retail store (e.g., boxed food items, canned food items, cleaning supply items, produce items, frozen food items, consumer electronic goods, health products, beauty products, and other such items) that are positioned on product support devices 202 (e.g., shelves 304, modulars, racks, endcaps, etc.). At least some and in some instances most if not all of the items 302 include at least one RFID tag 112. The product support devices 202 are positioned throughout the retail store 200. The placement of the product support devices 202 establishes travel areas 204 along which people 206 (e.g., customers, workers, etc.) and other objects can move through the retail store 200, with at least some of the travel areas 204 being large enough to allow shopping carts 208, pallet jacks, baskets, and/or other movable objects to be moved through the retail store.

In some embodiments, the RFID customer tracking system 100 further includes or communicatively couples with an inventory system 114 that maintains and updates an inventory database of products believed to be available at the retail store, and in some instances products ordered and expected to be received. The inventory system 114 may include a product ordering system or the RFID customer tracking system 100 may include a separate product ordering system that communicates with at least the inventory system. Further, the RFID customer tracking system 100 may include and/or couples with one or more scheduling systems 116 that schedule workers, tasks to be performed at the retail store, and/or other such scheduling. In some embodiments, the RFID customer tracking system 100 further includes and/or communicatively couples with user interface units 118 (e.g., smartphones, tablets, scanning devices, and/or other such devices that are utilized by workers at the retail store), and/or the tracking control circuit is in communication with customer user interface units (e.g., smartphones, tablets, etc.) or receives communications via the distributed network 108 (e.g., the Internet) from a separate network server associated with the retail store.

In some embodiments, the tracking control circuit may further control one or more systems (e.g., RFID tag readers, lighting systems, advertisement systems, product scanning systems, etc.) at the retail store, and use the location information of one or more customers, workers, carts, and/or other such objects in controlling these systems. Additionally or alternatively, one or more retail store central control circuits 120 or power consumption control circuits may be included in the RFID customer tracking system 100 and/or are communicatively coupled via the one or more network 108 with the tracking control circuit 106. The central control circuit may further communicatively couple with the RFID tag readers 104, video surveillance cameras and/or systems, other security systems, lighting control systems, advertisement systems, product scanning systems (e.g., Scan&Go systems from Wal-Mart Stores, Inc.), and/or other such systems operating at the retail store. Location information and/or predicted direction of movement of one or more customers, carts, workers and/or other objects can be communicated to the central control circuit 120. Based on this location information and/or movement tracking information, the tracking control circuit 106 and/or the central control circuit 120 can activate, deactivate, power down, shift to a sleep mode, shift to a reduced power consumption mode one or more systems at the retail store 200. This control of these various systems throughout the retail store can result in reduced power consumption, reduced operational time of systems, and other such benefits.

The RFID tag readers 104 are positioned in various locations and in some instances various orientations relative to the items 302 and corresponding RFID tags 112. In some implementations one or more of the RFID tag readers 104 are positioned overhead (e.g., secured within the ceiling and/or suspended from the ceiling). Other RFID tag readers may be secured with product support devices 202, positioned on or within the floor, secured with movable devices, or otherwise positioned to receive RFID signals from one or more, and typically a subset of RFID tags 112. As introduced above, at least some of the RFID tag readers 104 may be positioned in a grid pattern relative to at least one or more portions of the sales floor. Further, many of the RFID tag readers are positioned to receive RFID signals from RFID tags 112 positioned across one or more travel areas 204. As such, objects (e.g., people 206, carts 208, pallets of products, pallet jacks, baskets, and the like) moving along those travel areas 204 may pass between an RFID tag reader 104 and some of the RFID tags 112, which often interferes with RFID tag signals detected at the RFID tag reader.

Because at least some of the RFID tags 112 are cooperated with items 302 intended to be purchased by customers, the RFID tags change over time. For example, RFID tags are removed not to be returned when customers remove a product, and different RFID tags are later positioned in their place when workers restock the shelf 304 or other product support 202. Accordingly, the tracking control circuit 106 can further track the loss of detection of RFID tags. In some instances, when the loss is greater than a removal threshold period of time, the tracking control circuit considers the corresponding item 302 and accompanying RFID tag 112 to have been removed by a customer. This removal of an item may further be confirmed when the RFID tag corresponding to that item is subsequently detected by a different RFID tag reader 104 that previously had not detected the RFID tag indicating a movement of the RFID tag, detected at a point-of-sale (POS) system of the retail store, or other such confirmation of removal. Similarly, the tracking control circuit often receives RFID tag information from new RFID tags 112 from a particular RFID tag reader 104 that previously had not detected that RFID tag. When that tag is repeatedly detected a threshold number of times or over a threshold period of time, the tracking control circuit 106 may designate that new RFID tag as a newly stocked item. Additionally or alternatively, confirmation of restocking may be received from an RFID tag reader, a separate bar code reader, or other product identifying system operated by a worker or otherwise implemented as items are restocked on the shelf 304 or other product support system 202.

The RFID tag readers 104 are each positioned and configured to detect a set of at least one and typically multiple different RFID tags 112 that are each associated with one of the multiple different items 304 of products offered for sale at the retail store. Further, at least some and in many instances all of the RFID tags are unique having a unique identifier that uniquely identifies the specific item 304 with which the RFID tag is associated. The tracking control circuit is configured to receive, from a set of RFID tag readers 104 of the multiple RFID tag readers at the retail store, RFID tag information of each RFID tag of a detected subset of the multiple RFID tags 112. For example, an RFID tag may be positioned with a read area that covers a subset of items 302 placed on a particular product support device 202. RFID tag signals are detected by the RFID tag readers, typically in response to the RFID tag reader emitting a read signal. RFID tag information is received and/or determined based on the received RFID signals from the RFID tags 112. For example, the RFID tag information may include tag identifier information of the RFID tag transmitting the signal and/or corresponding item, receive signal strength indicator (RSSI) determined from the received signal, a read rate at which a particular RFID tag is read, which one or more antennas of an RFID tag reader are detecting, angle of reception, and/or other such RFID tag information.

Further, each of the RFID tag readers 104 and/or the tracking control circuit 106 are configured to track over time the RFID tag information of RFID tags 112 being read at each of the RFID tag readers, and determine from this tracking over time a set of base information from the received RFID signals from each RFID tag 304 being read. This set of base information can be defined by an average; a mean; a median; within a range (e.g., less than two standard deviations, within a threshold, etc.); other statistically determined value, other base information, or a combination of two or more of such base data. Further, the determined base information may be determined taking into consideration variations, which may include discarding some information, such as information deemed beyond a threshold, different by two or more standard deviations, some other variation dictated by one or more rules. For example, some embodiments identify a series of variations in RSSI and/or read rate greater than a cart threshold range and/or variations occurring within a threshold time when a cart 208 passes between an RFID tag 112 and an RFID tag reader 104, a threshold reduction in RSSI and/or read rate greater than a person threshold when a person passes between an RFID tag 112 and an RFID tag reader 104.

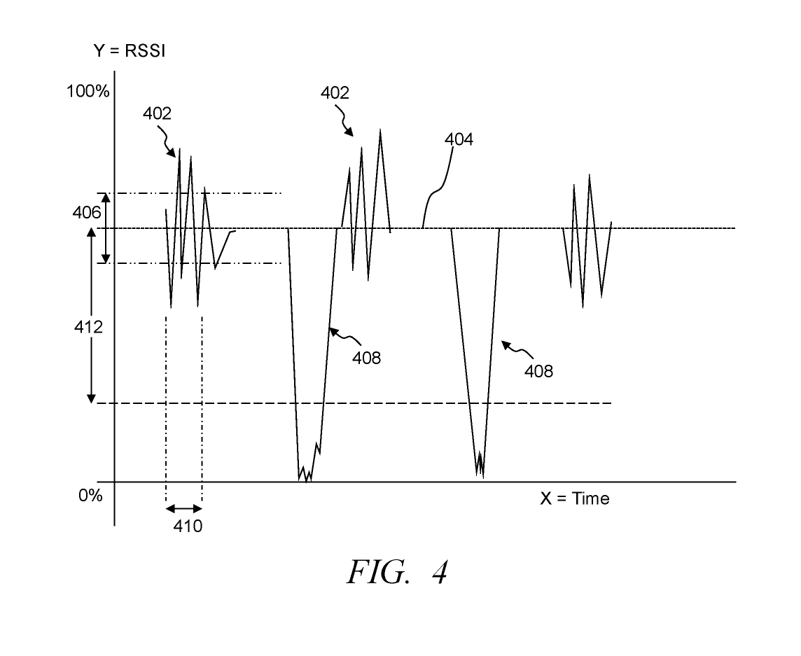

FIG. 4 illustrates a simplified graphical representation of exemplary RSSI and read rates corresponding to an RFID tag over time, in accordance with some embodiments. It has been determined that due to the interference, absorption and/or reflection of RFID signals caused by carts 208, the cart RSSI variations 402 or fluctuations (cart RSSI variations) are at levels and/or rates that are greater than a base RSSI 404 detected when there is nothing between an RFID tag and an RFID tag reader. The base RSSI 404 is illustrated as a line, which may correspond to an average, mean, or some other determined base. In some instances, the base RSSI is defined by a range determined based on fluctuations in RSSI detected over time, when a cart, person or other temporary object is temporarily between the RFID tag and RFID tag reader. Accordingly, an RSSI threshold range 406 from an average or other base RSSI 404 can be identified over time that corresponds to cart RSSI variations 402 when a cart 208 passes between an RFID tag and an RFID tag reader. Further, some embodiments evaluate the duration of fluctuation relative to a threshold fluctuation duration 410 or range of durations corresponding to carts passing between a set of RFID tags 112 and one or more RFID tag readers 104.

This fluctuation may be learned over time based on scheduled “training” of the system, based on repeated detection of similar fluctuations that are within threshold variations, and/or other such detected consistent changes. Further, in some embodiments, the RSSI threshold range can be specific to a particular RFID tag 112 and a particular RFID tag reader 104, while in other instances, the RSSI threshold range may be determined based on a set of RFID tags relative to one or more RFID tag readers.

Additionally, it has been determined that due to absorption and interference caused by a person 206 passing between an RFID tag 112 and an RFID tag reader 104, the RSSI fluctuates including absorption RSSI drops 408, which is typically a greater drop than detected when a cart passes between the RFID tag and RFID tag reader. Accordingly, over time a person RSSI threshold change 412 can be determined that corresponds to a person passing between the RFID tag 112 and an RFID tag reader 104. Again, in some instances, the RSSI threshold change 412 can be specific between a particular RFID tag reader 104 and an RFID tag 112, while in other instances may be determined based on a set of RFID tags and one or more RFID tag readers. For example, the cart RSSI variation 402 may correspond to a 20 dBm, 40 dBm or other such change, while the person RSSI threshold change may correspond to an 80% reduction in RSSI over a period of time, substantially a complete lack of detected signal over a period of time, or other such change caused by the absorption and/or interference. For example, a baseline RSSI for a subset of RFID tags 112 of items 302 may have an RSSI value of approximately −40 dBm when nothing is between the RFID tags and the RFID tag reader 104. The RSSI value corresponding to the same RFID tags when something is located between the RFID tag reader 104 and the tags may have an RSSI value of approximately −60 dBm. When an object, such as a cart 208 or basket is interfering with or enhancing the RFID signal, the RSSI value will similarly change. For example, the RSSI value may decrease when objects are between the RFID tags 112 and the RFID tag reader 104. Additionally, dependent upon the object, the RSSI value may increase when the object is positioned between an RFID tags 112 and an RFID tag reader 104. The presence of an object can be determined based on these fluctuations from the baseline value. That is, when the RFID signal is different than the baseline value by a threshold and/or for a threshold period of time, one or more rules may dictate that an object is positioned between the RFID tag 112 and the RFID tag reader 104. Still further, some embodiments consider sequential sets of RFID tags 112 that are affected by an object in determining whether the object is a person, cart, basket, or other object. Because carts 208 are relatively uniform in size (e.g., length, width, height, etc.), the amount of time that a signal is affected (e.g., reduction in RSSI, reduction or increase in read rate, different antenna, difference in a “non-read” period, etc.) from an RFID tag 112 is indicative of a cart 208 passing between the RFID tag and an RFID tag reader 104. In addition consistent patterns in affected signals of different RFID tags and/or sets of RFID tags can be used to distinguish between objects (e.g., smaller clusters of RFID tags separated by a distance can be used to distinguish between a person's legs or feet interfering with RFID tags, versus a continuous affect for a period of time corresponding to a cart passing between a set of RFID tags and an RFID tag reader).

In some instances, the direction from which the RFID signal is detected and/or emanates can be used to determine or estimate the type of object (e.g., reflections, different RFID tags within a cart or basket, etc.). For example, an object in a cart 208 or basket may reflect an RFID signal, causing the reflected RFID signal to be detected by an antenna that is different than another antenna that would typically receive the signal, and/or the reflected RFID signal may be read by an RFID tag reader 104 that would not typically read an RFID signal from that RFID tag.

Some embodiments further evaluate the fluctuations to determine dwell times and/or durations that a customer is at a location or within an area. For example, one axis of the graphical representation may correspond to time. Accordingly, the width of the fluctuation may correspond to a time the object is interfering with the reading of the RFID tags and/or positioned at least partially between the RFID tag readers 104 and the RFID tags. The dwell times can be used to evaluate the customer's shopping habits, predict inventory changes, evaluate product placement (e.g., extended dwell times by customers may indicate they are having difficulty finding a product), and/or other such information. Similarly, dwell times may be used to evaluate whether customers are considering advertisements, changes in pricing, and/or other such factors.

Referring to FIGS. 1-4, the tracking control circuit 106 communicatively couples with the multiple RFID tag readers 104 over one or more distributed networks 108 (e.g., local area network (LAN), wide area network (WAN), Internet, wireless (e.g., Bluetooth, Wi-Fi, etc.), and/or other such networks). In some embodiments, the tracking control circuit includes and/or accesses memory storing code, and in implementing the code is configured to receive, from a set of one or more RFID tag readers 104, RFID tag information of each RFID tag of a detected subset of RFID tags 112 of RFID tags. One or more rule sets can be accessed and obtained that are applied to identify changes in RFID tag information. The one or more rule sets can be applied and used by the tracking control circuit 106 to evaluate over time the received RFID tag information and identify over time threshold changes from the set of base information of received RFID signals from the array of RFID tags 112 being read at each of the set of RFID tag readers. The rules can include applying one or more thresholds, statistical evaluations (e.g., determining an average, a median, a mode, a maximum, etc.), confirming changes over a threshold time, and/or other such rules. In other embodiments, one or more of the rule sets may be applied by the RFID tag reader.

As described above, the detected threshold change in some embodiments is consistent with an object (e.g., person, cart, pallet jack, basket, etc.) traveling between a subset of RFID tags 112 and a corresponding one of the set of RFID tag readers 104. Further, the tracking control circuit 106 is configured to utilize the detected changes in RFID tag information over time to track the object without obtaining a unique identifier of the object as the object moves relative to the RFID tags 112 and along one or more of the travel areas 204 of the retail store 200. The location and tracking of movement of the object, in some embodiments, is determined as a function of the detected changes from the base information 404 of the received RFID signals from the subset of RFID tags 112 being read over time. Again, the retail store includes multiple different RFID tag readers 104 distributed about the retail store 200. In many implementations, RFID signals transmitted by the same subset of RFID tags 112 are detected by multiple different RFID tag readers 104. As changes in RFID tag information are detected over time, those changes can correspond to movement along the travel areas 204 of the retail store. Further, a single RFID tag reader 104 may detect changes in RFID tag information from a first subset of RFID tags 112 of items 302, and subsequently detect changes to a second subset of RFID tag information from a second subset of RFID tags 112 (e.g., a neighboring subset of items). Similarly, the detected RFID tag information from the first subset of RFID tags may return to base levels corresponding to the object passing beyond the first subset of RFID tags and no longer being between the first subset of RFID tags and the RFID tag reader. This change and/or return to the base information allows the tracking control circuit 106 to detect the movement of the object, and based on the sequence of the detected changes of different RFID tags the tracking control circuit can identify a direction of travel of the object, and in some instances a speed of movement of the object. Further, as items 302 are moved through the retail store different RFID tag readers receive signals from those items being moved (e.g., by a customer, worker, etc.) through the retail store. The sequential detected changes in RFID tag information corresponding to moving RFID tags can be used to track the movement of the object through the retail store 200. In some embodiments, the tracking control circuit 106 uses one or more sets of rules to evaluate, over time and for each of the subset of RFID tags, the RFID tag information and identify over time threshold changes from the set of base information 404 of received RFID signals from the subset of RFID tags being read at each of the set of the RFID tag readers 104 positioned along a travel area 204 within the retail store. Further, the tracking control circuit may identify that threshold changes at each of the set of RFID tag readers is consistent with the same object moving to be positioned proximate a respective RFID tag reader 104 and a subset of the multiple items 302 corresponding to the subset of RFID tags.

The tracking control circuit 106 can be configured, in some implementations, to track an object (e.g., person 206, cart 208, basket, etc.) without obtaining the identifier of the object as the object moves along at least a portion of the travel areas 204 of the retail store as a function of timing of the detected changes from the base information 304 in one or more characteristics of the RFID tag information of the received RFID signals from the subset of RFID tags 112 being read at each of the RFID tag readers 104 of the set of RFID tag readers. The timing of the detected changes in RFID information can further be utilized by the tracking control circuit in determining a location, direction of travel and/or track the movement of the object through one or more portions of the retail store. Further, the consistency between changes in different RFID information corresponding to different RFID tags is utilized by the tracking control circuit as at least part of a confirmation that the same object is causing the changes in RFID information. In some embodiments, the tracking control circuit 106 uses a set of rules in tracking the object to confirm that the detected changes in at least one characteristic of the RFID tag information corresponding to a subsequent set of RFID tags being read at a subsequent RFID tag reader of a sub-set of RFID tag readers are within a threshold consistency of detected changes in the at least one characteristic of RFID tag information corresponding to a previous set of multiple RFID tags being read at a previous RFID tag reader of the sub-set of RFID tag readers. The tracking control circuit can associate the changes in RFID tags being read at the subsequent RFID tag reader as being causes by the same object based on the determined consistency within threshold variations of the one or more characteristics. The tracking control circuit can be configured to continue to track the object throughout the retail store based on the continued detected changes in one or more parameters of RFID signals of the RFID tags being read at each of a subsequent set of RFID tag readers, and determine a path of the object through the retail store. The tracking control circuit 106 may, in some implementations, additionally utilize the repeated detection at different RFID tag readers corresponding to detected movement of item RFID tags (e.g., that have been placed in a cart) and utilize the consistent detection at different RFID tag readers 104 in confirming the same cart and in tracking the movement of one or more objects. In some embodiments, the tracking control circuit 106, in using the set of rules in tracking the object is configured to confirm that the detected changes in RFID tags being read at a subsequent RFID tag reader are within a threshold consistency of detected changes in RFID tags being read at a previous RFID tag reader. The changes in RFID tags being read at the subsequent RFID tag reader can be associated with being causes by the object based on the determined consistency.

Further, in some implementations, the tracking control circuit 106, in using the set of rules to identify the changes in the RFID tags 112 and/or one or more parameters of an RFID signal from the RFID tags being read at each of the set of the RFID tag readers 104, is configured to identify at least a threshold increase in RFID tags being read at each of the set of RFID tag readers associated with reflected RFID tag signals reflecting from the object as the object is moved along one or more travel areas 204 of the shopping facility. For example, an RFID tag may not detect some RFID tags. However, as the object is moved along a travel areas, RFID tags may reflect from the object allowing the RFID tag reader to receive an RFID tag signal from one or more RFID tags that previously were not being received when the object was not at the location. Further, the one or more rules and/or parameters may limit when the tracking control circuit considers such additional reads. In some embodiments, for example, the tracking control circuit 106 identifies when there is at least a threshold increase in a number of RFID tags being read that were previously unread for more than a threshold period of time, which can correspond to at least a threshold increase in RFID tags being read. Again, this increase corresponds to the movement of an object. The tracking control circuit 106 can use the detected change in RFID tags being detected over sequential time periods and corresponding to different subsets of RFID tag 112 and/or different RFID readers to track the movement of the object.

Additionally or alternatively, the RFID readers may detect RFID signals at different antennas of the RFID tag reader than were previously detecting an RFID tag signal. As introduced above, many of the RFID tag readers 104 are fixed in predefined position within the retail store relative to one or more product support devices 202 items 302. The tracking control circuit can use one or more sets of rules to identify the changes in the RFID tags being read to identify a decrease of at least a first threshold change in RFID tags being read through a first RFID tag reader antenna of an RFID tag reader, and an increase of at least a second threshold change in RFID tags being read through a second RFID tag reader antenna of the RFID reader.

In some instances, the tracking control circuit 106 additionally or alternatively uses one or more sets of rules to identify that changes in the RFID tags being read at each of the set of the RFID tag readers 104 is at least a threshold decrease in a number of RFID tags that were previously being read at each of the set of RFID tag readers. The decrease in the number of RFID tags being detected typically corresponds to an increase in absorption by one or more objects being positioned between the subset of RFID tags 112 and the one or more RFID tag readers 104. For example, as a person moves along a travel area 204, consistent decreases in a number of RFID tags being read are often seen over time from different subsets of RFID tags 112. This decrease in numbers of RFID tags may further be accompanied by threshold decreases in RSSI of RFID tags. Accordingly, the tracking control circuit can track movement of the object based at least in part on the detected decreases and/or changes in the number of RFID tags being read.

In some embodiments, the tracking control circuit obtains one or more sets of rules to detect an error in tracking. The one or more sets of rules can be used relative to the changes in parameters of RFID signals being detected to detect an instance where the change in the RFID tags being read cannot definitively be associated with one of a first object and a second object that are both moving along a travel area 204. Based on continued tracking of both the first object and the second object and corresponding changes in subsequent RFID tag reads, the tracking control circuit in some instance can identify that a portion of the determined path of the first object after the detection of the instance where the change in RFID tags being read could not be associated with one of the first object and the second object. The tracking control circuit can replace identified portion of the determined path associated with the first object, with a corresponding portion of a determined path associated with the second object after the detection of the instance where the change in RFID tags being read could not be associated with one of the first object and the second object. In some implementations, the tracking control circuit is further configured to determine an object's direction of travel based on the affected RFID tags 112. In some embodiments, the tracking control circuit, in using a direction evaluation set of one or more rules and/or criteria, is configured to identify a direction the object (e.g., customer, worker, cart, basket, etc.) is traveling based on detected sequential sets of the affected RFID tags 112.

Some embodiments further utilize the tracked location to control systems and resources throughout the retail store. By identifying the location of customer, workers and the like, the RFID customer tracking system 100 can control lighting systems, advertisement system, security systems, cameras, RFID tag readers, sensors, and other such systems within the retail store depending on locations of objects and/or directions of travel of objects. In some embodiments, the tracking control circuit 106 further couples with lighting systems and surveillance systems of the retail store, advertisement system, other security systems, cameras, RFID tag readers, sensors, and other such systems within the retail store. Based on location information corresponding to one or more tracked objects within the retail store the tracking control circuit is configured to activate, deactivate, power down, force to a sleep mode, change to a lower power consumption mode, change to a full on mode, and/or other such triggering. This can reduce the retail store power consumption, processing power, and other overhead, while improving efficiency, and without adversely affecting the customer experience and/or without adversely affecting worker productivity. For example, the tracking control circuit may issue instructions and/or commands to one or more lighting systems, one or more the surveillance systems and/or one or more RFID tag readers based on the location of one or more objects. As a specific example, the tracking control circuit 106 may utilize location information and/or tracked movement of customers to identify that there is no one within a threshold of an area of the shopping retail store, and direct the powering down of RFID tag readers and other sensors in that area, and direct one or more lighting systems corresponding to that area to be dimmed to a predefined lower power consumption mode. The tracking control circuit 106 and/or the central control circuit 120 may evaluate the location of the object relative to one or more thresholds (e.g., security camera threshold, lighting control threshold, advertisement control threshold, Scan&Go control threshold, and/or other such thresholds). For example, the object may be a customer and security components (e.g., cameras, sensors, etc.) may be powered down when the customer leaves an isle while lighting is maintained on; and may direct one or more lighting systems when the customer is three isles away, is 25 ft. from an area of the store, or some other threshold. In other instances, the tracking control circuit 106 may predict that a customer is expected to enter a certain area of the retail store based on a current location and the tracked movement of the customer (e.g., based on tracked movement the tracking control circuit knows where the customer has previously been, based on a shopping list, etc.), and direct the operation of lighting systems corresponding to that area to be at a desired level while the customer is in that area, direct the activation of one or more RFID tag readers and/or barcode readers, direct the activation of security cameras, and/or other such controls.

In some embodiments, the system includes a scheduling system 116 that is in communication with the tracking control circuit 106 and/or the central control circuit 120. Tasks can be identified that are to be performed based on the location, previous route and/or expected route of one or more objects. In some instances, the tracking control circuit can direct that a task is to be perform and notifies the scheduling system 116. The tracking control circuit can provide location information to the scheduling system to be used in instructing the task. Based on the task, the scheduling system can evaluates workers, scheduled task, expected tasks and the like to determine one or more workers to perform the task and schedules the task. The one or more workers are notified of the task and the scheduling of when that task is to be performed. Examples may include picking up a cart left for an extended period, helping a customer based on a dwell time in a particular location or area for more than a threshold, and/or other such tasks. Similarly, in some embodiments the tracking control circuit may evaluate quantities of customers passing through areas and their dwell times to predict levels of inventory. Information can be communicated to the inventory system 114 that may use this information in determining whether to direct restocking, reordering, and the like.

As described above, the detected change in RFID information may correspond to increases in detection rate, decreases in detection rate, increases in signal strength, detecting RFID tags that were previously not detected by a particular RFID tag reader 104, identifying a change in antenna detecting an RFID signal, and/or other such changes. In some embodiments, the tracking control circuit 106 is configured to obtain a tracking set of rules to track one or more objects, and to use the tracking set of rules to evaluate RFID tag information and identify a loss of detection of at least a cluster of RFID tags 112 at the same time with the cluster of RFID tags being tags that are close in proximity to each other and typically adjacent each other. This loss may result from an object (e.g., a person) absorbing RFID signals, items within a cart absorbing RFID signals, a cart interfering with an RFID tag reader from accurately receiving RFID signals, and/or other such losses. For example, in some instances the tracking control circuit may detect the threshold change corresponding to RFID tags 112 being blocked by a cart 208 and/or person 206.

Further, the detected threshold changes in one or more characteristics of an RFID signal from a one or more RFID tags of a set of RFID tags 112 may further be utilized in approximating a size of an object that is being detected and/or tracked. In some embodiments, the tracking control circuit 106 is configured to obtain a size estimation set of rules to track the object. The size estimation set of rules can be used by the tracking control circuit to evaluate RFID tag information and estimate a size of the object based on a quantity of the RFID tags 112 of a grouping of RFID tags that each have at least a threshold change from a base level of one or more signal parameters (e.g., a threshold reduction in detected signal strength from a base signal strength). In some instances, a threshold number of the affected RFID tags 112 are confirmed to be clustered (e.g., adjacent to another affected RFID tag, or within a threshold distance of one or more other affected RFID tags). In some instances, a quantity of RFID tags 112 of the cluster may be confirmed by one or more subsequent clusters of affected tags having a similar number of affected RFID tags (e.g., within a threshold+/−variation). The size estimation set of rules may include and/or refer to a reference table that correlates a quantity of affected RFID tags to one or more estimated sizes (e.g., height, width, weight, etc.), may correlate a distance between sequential clusters of affected RFID tags and the quantities of affected RFID tags to one or more estimated sizes, rates or times between sequential affected clusters may be correlated to size, different dwell times and quantities of affected RFID tags during those dwell times may be correlated to estimated sizes, a combination of two or more of such correlations may be used, and/or other such rules. The correlations may be learned over time based on average sizes of customers, learned sizes of people relative to detected blocked clusters of RFID tags, and the like.

Further, some embodiments are configured to estimate a customer's age based on a quantity of the RFID tags blocked at a given time and/or sequential clusters of RFID tags detected. The tracking control circuit 106, in some embodiments, is configured to obtain an age estimation set of rules to track the first object, and use the age estimation set of rules to evaluate RFID tag information and identify the object is a customer and estimate an age of the customer based on detected sequential sets of the RFID tags of one or more arrays of RFID tags that each have at least a threshold change (e.g., threshold reduction in detected signal strength, threshold change in read rate, lack of detected signal for a threshold period, etc.) in one or more RFID information characteristics. Typically, the sequential sets of the RFID tags of the one or more arrays of RFID tags are sequential in time. Further, the rules may correlate distances between sets of affected tags and/or rates of change to ages, correlate distances between sets of affected tags and the quantity of affected tags in the sets (e.g., an average quantity) to ages, correlate rates of occurrences of the sequential sets to ages, dwell times relative to sizes of affected tags of sets may be correlated to age, dwell times relative to types of products, two or more of such correlations may be used, and/or other such rules.

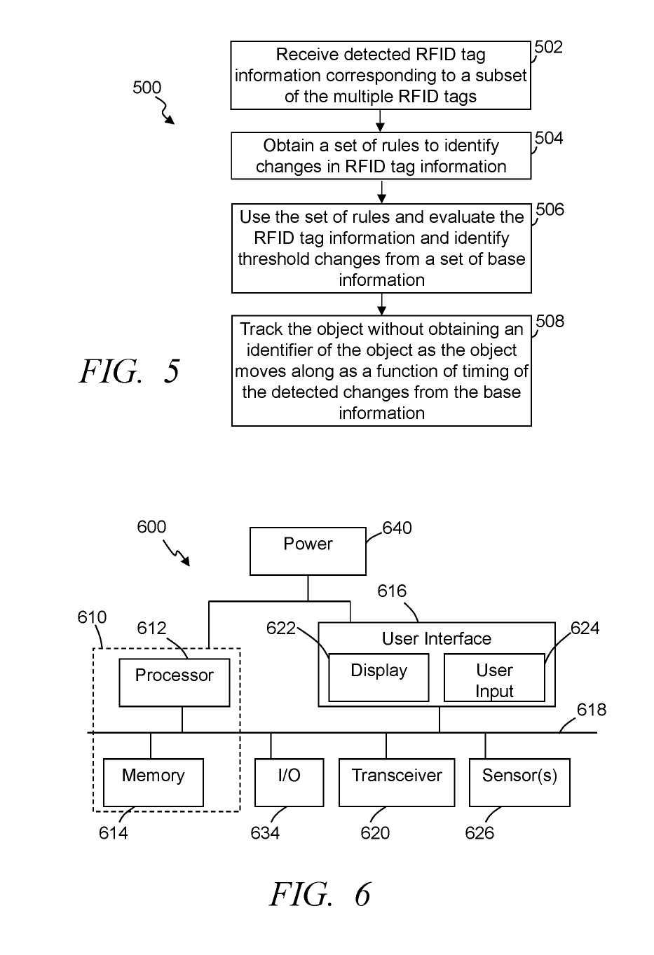

FIG. 5 illustrates a simplified flow diagram of an exemplary process 600 of tracking customers and/or other objects through a retail store 200 based on RFID signals, in accordance with some embodiments. In step 502, detected RFID tag information is received from a set of RFID tag readers 104 of multiple RFID tag readers distributed about the retail store. Again the RFID tag readers are configured to detect a set of different RFID tags 112 that are each associated with one of multiple different items 302 of products offered for sale at the retail store. In some embodiments, the detected RFID tag information correspond to each RFID tag of a subset of the multiple RFID tags.

In step 504, one or more sets of rules are obtained to identify changes in RFID tag information. In step 506, the one or more sets of rules are used in evaluating, over time and for each of the subset of RFID tags, the RFID tag information and identifying over time threshold changes from a set of base information of received RFID signals from the subset of RFID tags being read at each of a set of RFID tag readers positioned along at least a first travel area within the retail store. The threshold change at each of the set of RFID tag readers can be consistent with an expected object moving to be positioned proximate the respective RFID tag reader 104 and a subset of the multiple items 302 corresponding to the subset of RFID tags 112. In step 508, the object is tracked, without obtaining an identifier of the object, as the object moves along one or more travel areas 204 as a function of timing of the detected changes from the base information of the received RFID signals from the subset of RFID tags 112 being read at each of the RFID tag readers 104 of the set of RFID tag readers.

In some embodiments, the tracking control circuit 106 continues to track one or more objects throughout the retail store based on the continued detected changes in the RFID tags being read at each of subsequent sets of RFID tag readers 104, and can determine a path of the object through the retail store. In tracking the object, some embodiments confirm that the detected changes in RFID tags being read at a subsequent RFID tag reader 104 are within a threshold consistency of detected changes in RFID tags being read at a previous different RFID tag reader. That changes in RFID tags being read at the subsequent RFID tag reader can be associated with being causes by the object based on the determined consistency. In identifying the changes in the RFID tags being read at each of the series of the RFID tag readers, some embodiments identify at least a threshold increase in RFID tags being read at each of the set of RFID tag readers associated with reflected RFID tag signals reflecting from the first object. The identification of at least the threshold increase in RFID tags being read can include identifying at least a threshold increase in RFID tags being read that were previously unread for more than a threshold period of time.

Some embodiments, in identifying the changes in the RFID tags being read at each of the set of the RFID tag readers, identify at least a threshold decrease in RFID tags previously being read at each of the set of RFID tag readers. Additionally or alternatively, the identification of the changes in the RFID tags being read can include identifying a decrease of at least a threshold change in RFID tags being read through a first RFID tag reader antenna, and an increase of at least a second threshold change in RFID tags being read through a second RFID tag reader antenna. In some instances, a one or more set of rules are obtained to detect an error in tracking, and are used to detect an instance where the change in the RFID tags being read cannot definitively be associated with one of two different objects (e.g., two objects traveling along the same or similar portions of a travel area 204). The tracking control circuit can identify, based on continued tracking of both the first object and the second object that the changes in subsequent RFID tag reads, that a portion of the determined path of one of the two objects after the detection of the instance where the change in RFID tags being read could not be associated with one of the two objects, and can replace a portion of the determined path associated with the one object, with a corresponding portion of a determined path associated with the other object after the detection of the instance where the change in RFID tags being read could not be associated with one of the two objects. The system may include and/or couple with one or more other systems at the retail store that can be activated, deactivated, put into a low power mode or otherwise modified in operation based on the tracked objects. Some embodiments identify that an object is a threshold distance from a travel area, and can control a lighting system and/or one or more RFID tag readers 104 corresponding to the travel area based on the tracked location of the object.

In some instances, a set of rules to track the object can be obtained and used to evaluate RFID tag information and estimating a size of an object based on a quantity of the RFID tags 112 of an array of RFID tags that each have at least a threshold reduction in detected signal strength from the base signal strength.

Further, the circuits, circuitry, systems, devices, processes, methods, techniques, functionality, services, servers, sources and the like described herein may be utilized, implemented and/or run on many different types of devices and/or systems. FIG. 6 illustrates an exemplary system 600 that may be used for implementing any of the components, circuits, circuitry, systems, functionality, apparatuses, processes, or devices of the retail store RFID customer tracking system 100, the RFID tag readers 104, the tracking control circuit 106, the central control circuit 120, and/or other above or below mentioned systems or devices, or parts of such circuits, circuitry, functionality, systems, apparatuses, processes, or devices. For example, the system 600 may be used to implement some or all of an RFID tag reader 104, the tracking control circuit 106, and/or other such components, circuitry, functionality and/or devices. However, the use of the system 600 or any portion thereof is certainly not required.

By way of example, the system 600 may comprise a control circuit or processor module 612, memory 614, and one or more communication links, paths, buses or the like 618. Some embodiments may include one or more user interfaces 616, and/or one or more internal and/or external power sources or supplies 640. The control circuit 612 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 612 can be part of control circuitry and/or a control system 610, which may be implemented through one or more processors with access to one or more memory 614 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 600 may be used to implement one or more of the above or below, or parts of, components, circuits, systems, processes and the like.

The user interface 616 can allow a user to interact with the system 600 and receive information through the system. In some instances, the user interface 616 includes a display 622 and/or one or more user inputs 624, such as buttons, touch screen, track ball, keyboard, mouse, etc., which can be part of or wired or wirelessly coupled with the system 600. Typically, the system 600 further includes one or more communication interfaces, ports, transceivers 620 and the like allowing the system 600 to communicate over a communication bus, a distributed computer and/or communication network 108 (e.g., a local area network (LAN), the Internet, wide area network (WAN), etc.), communication link 618, other networks or communication channels with other devices and/or other such communications or combination of two or more of such communication methods. Further the transceiver 620 can be configured for wired, wireless, optical, fiber optical cable, satellite, or other such communication configurations or combinations of two or more of such communications. Some embodiments include one or more input/output (I/O) ports 634 that allow one or more devices to couple with the system 600. The I/O ports can be substantially any relevant port or combinations of ports, such as but not limited to USB, Ethernet, or other such ports. The I/O interface 634 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 626 to provide information to the system and/or sensor information that is communicated to another component, such as the central control circuit 120, scheduling system 116, the tracking control circuit 106, etc. The sensors can include substantially any relevant sensor, such as distance measurement sensors (e.g., optical units, sound/ultrasound units, etc.), optical based scanning sensors to sense and read optical patterns (e.g., bar codes), and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 600 comprises an example of a control and/or processor-based system with the control circuit 612. Again, the control circuit 612 can be implemented through one or more processors, controllers, central processing units, logic, software and the like. Further, in some implementations the control circuit 612 may provide multiprocessor functionality.

The memory 614, which can be accessed by the control circuit 612, typically includes one or more processor readable and/or computer readable media accessed by at least the control circuit 612, and can include volatile and/or nonvolatile media, such as RAM, ROM, EEPROM, flash memory and/or other memory technology. Further, the memory 614 is shown as internal to the control system 610; however, the memory 614 can be internal, external or a combination of internal and external memory. Similarly, some or all of the memory 614 can be internal, external or a combination of internal and external memory of the control circuit 612. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 108. The memory 614 can store code, software, executables, scripts, data, content, lists, programming, programs, log or history data, user information, customer information, product information, and the like. While FIG. 6 illustrates the various components being coupled together via a bus, it is understood that the various components may actually be coupled to the control circuit and/or one or more other components directly.

In some embodiments, retail store RFID object tracking systems are provided and corresponding methods performed by the systems. The tracking system, in some embodiments, comprises: multiple RFID (radio frequency identification) tag readers distributed throughout a retail store each configured to detect a set of at least one of multiple different RFID tags that are each associated with one of multiple different items of products offered for sale at the retail store; and a tracking control circuit communicatively coupled with the multiple RFID tag readers, implementing code stored on memory and configured to: receive, from a set of RFID tag readers of the multiple RFID tag readers, RFID tag information of each RFID tag of a detected subset of the multiple RFID tags; obtain a first set of rules to identify changes in RFID tag information; use the first set of rules to evaluate, over time and for each of the subset of RFID tags, the RFID tag information and identify over time threshold changes from a set of base information of received RFID signals from the subset of RFID tags being read at each of the set of the RFID tag readers positioned along at least a first travel area within the retail store, wherein the threshold change at each of the set of RFID tag readers is consistent with a first object moving to be positioned proximate the respective RFID tag reader and a subset of the multiple items corresponding to the subset of RFID tags; and track the first object without obtaining an identifier of the first object as the first object moves along at least the first travel area as a function of timing of the detected changes from the base information of the received RFID signals from the subset of RFID tags being read at each of the RFID tag readers of the set of RFID tag readers.

Further, some embodiments provide methods of tracking customer paths through a retail store, comprising: multiple RFID (radio frequency identification) tag readers distributed throughout a retail store each configured to detect a set of at least one of multiple different RFID tags that are each associated with one of multiple different items of products offered for sale at the retail store; by a tracking control circuit: receiving, from a set of RFID tag readers of multiple RFID tag readers distributed about the retail store and configured to detect a set of at least one of multiple different RFID tags that are each associated with one of multiple different items of products offered for sale at the retail store, detected RFID tag information corresponding to each RFID tag of a subset of the multiple RFID tags; obtaining a first set of rules to identify changes in RFID tag information; using the first set of rules and evaluating, over time and for each of the subset of RFID tags, the RFID tag information and identifying over time threshold changes from a set of base information of received RFID signals from the subset of RFID tags being read at each of a set of RFID tag readers positioned along at least a first travel area within the retail store, wherein the threshold change at each of the set of RFID tag readers is consistent with a first object moving to be positioned proximate the respective RFID tag reader and a subset of the multiple items corresponding to the subset of RFID tags; tracking the first object without obtaining an identifier of the first object as the first object moves along at least the first travel area as a function of timing of the detected changes from the base information of the received RFID signals from the subset of RFID tags being read at each of the RFID tag readers of the set of RFID tag readers.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A retail store customer tracking system, comprising:
multiple RFID (radio frequency identification) tag readers distributed throughout a retail store each configured to detect a set of at least one of multiple different RFID tags that are each associated with one of multiple different items of products offered for sale at the retail store; and
a tracking control circuit communicatively coupled with the multiple RFID tag readers, implementing code stored on memory and configured to:
receive, from a set of RFID tag readers of the multiple RFID tag readers, RFID tag information of each RFID tag of a detected subset of the multiple RFID tags;
obtain a first set of rules to identify changes in RFID tag information;
use the first set of rules to evaluate, over time and for each of the subset of RFID tags, the RFID tag information and identify over time threshold changes from a set of base information of received RFID signals from the subset of RFID tags being read at each of the set of the RFID tag readers positioned along at least a first travel area within the retail store, wherein the threshold change at each of the set of RFID tag readers is consistent with a first object moving to be positioned proximate the respective RFID tag reader and a subset of the multiple items corresponding to the subset of RFID tags; and
track the first object without obtaining an identifier of the first object as the first object moves along at least the first travel area as a function of timing of the detected changes from the base information of the received RFID signals from the subset of RFID tags being read at each of the RFID tag readers of the set of RFID tag readers.

2. The system of claim 1, wherein the tracking control circuit is configured to continue to track the first object throughout the retail store based on the continued detected changes in the RFID tags being read at each of a subsequent set of RFID tag readers, and determine a path of the first object through the retail store.

3. The system of claim 2, wherein the tracking control circuit using the first set of rules in tracking the first object is configured to confirm that the detected changes in RFID tags being read at a subsequent second RFID tag reader are within a threshold consistency of detected changes in RFID tags being read at a previous first RFID tag reader, and associate the changes in RFID tags being read at the second RFID tag reader as being causes by the first object based on the determined consistency.

4. The system of claim 1, wherein the tracking control circuit, in using the first set of rules to identify the changes in the RFID tags being read at each of the set of the RFID tag readers, is configured to identify at least a threshold increase in RFID tags being read at each of the set of RFID tag readers associated with reflected RFID tag signals reflecting from the first object.

5. The system of claim 4, wherein the tracking control circuit, in identifying at least the threshold increase in RFID tags being read, is configured to identify at least a first threshold increase in RFID tags being read that were previously unread for more than a threshold period of time.

6. The system of claim 1, wherein the tracking control circuit, in using the first set of rules to identify the changes in the RFID tags being read at each of the set of the RFID tag readers, is configured to identify at least a threshold decrease in RFID tags previously being read at each of the set of RFID tag readers.

7. The system of claim 1, wherein the multiple RFID tag readers are fixed in predefined position within the retail store, and wherein the tracking control circuit, in using the first set of rules to identify the changes in the RFID tags being read, is configured to identify a decrease of at least a first threshold change in RFID tags being read through a first RFID tag reader antenna, and an increase of at least a second threshold change in RFID tags being read through a second RFID tag reader antenna.

8. The system of claim 1, wherein the tracking control circuit is configured to obtain a second set of rules to detect an error in tracking, and use the second set of rules to detect an instance where the change in the RFID tags being read cannot definitively be associated with one of the first object and a second object also moving along the first travel area;
identify, based on continued tracking of both the first object and the second object and corresponding changes in subsequent RFID tag reads, that a portion of the determined path of the first object after the detection of the instance where the change in RFID tags being read could not be associated with one of the first object and the second object; and
replace the portion of the determined path associated with the first object, with a corresponding portion of a determined path associated with the second object after the detection of the instance where the change in RFID tags being read could not be associated with one of the first object and the second object.

9. The system of claim 1, the tracking control circuit further couples with lighting systems and surveillance systems of the retail store, and based on location information corresponding to the tracked first object within the retail store the tracking control circuit is configured to activate and deactivate some of the lighting systems, the surveillance systems and one or more RFID tag readers.

10. A method of tracking customer paths through a retail store, comprising:
by a tracking control circuit:
receiving, from a set of RFID tag readers of multiple RFID tag readers distributed about the retail store and configured to detect a set of at least one of multiple different RFID tags that are each associated with one of multiple different items of products offered for sale at the retail store, detected RFID tag information corresponding to each RFID tag of a subset of the multiple RFID tags;
obtaining a first set of rules to identify changes in RFID tag information;
using the first set of rules and evaluating, over time and for each of the subset of RFID tags, the RFID tag information and identifying over time threshold changes from a set of base information of received RFID signals from the subset of RFID tags being read at each of a set of RFID tag readers positioned along at least a first travel area within the retail store, wherein the threshold change at each of the set of RFID tag readers is consistent with a first object moving to be positioned proximate the respective RFID tag reader and a subset of the multiple items corresponding to the subset of RFID tags;
tracking the first object without obtaining an identifier of the first object as the first object moves along at least the first travel area as a function of timing of the detected changes from the base information of the received RFID signals from the subset of RFID tags being read at each of the RFID tag readers of the set of RFID tag readers.

11. The method of claim 10, further comprising:
continuing to track the first object throughout the retail store based on the continued detected changes in the RFID tags being read at each of subsequent set of RFID tag readers, and determine a path of the first object through the retail store.

12. The method of claim 11, wherein the tracking the first object comprises:
confirming that the detected changes in RFID tags being read at a subsequent second RFID tag reader are within a threshold consistency of detected changes in RFID tags being read at a previous first RFID tag reader; and
associating that changes in RFID tags being read at the second RFID tag reader as being causes by the first object based on the determined consistency.

13. The method of claim 10, wherein the identifying the changes in the RFID tags being read at each of the series of the RFID tag readers, comprises identifying at least a threshold increase in RFID tags being read at each of the set of RFID tag readers associated with reflected RFID tag signals reflecting from the first object.

14. The method of claim 13, wherein the identifying at least the threshold increase in RFID tags being read comprises identifying at least a first threshold increase in RFID tags being read that were previously unread for more than a threshold period of time.

15. The method of claim 10, wherein the identifying the changes in the RFID tags being read at each of the set of the RFID tag readers comprises identifying at least a threshold decrease in RFID tags previously being read at each of the set of RFID tag readers.

16. The method of claim 10, wherein identifying the changes in the RFID tags being read comprises identifying a decrease of at least a first threshold change in RFID tags being read through a first RFID tag reader antenna, and an increase of at least a second threshold change in RFID tags being read through a second RFID tag reader antenna.

17. The method of claim 10, further comprising:
obtaining a second set of rules to detect an error in tracking, and using the second set of rules to detect an instance where the change in the RFID tags being read cannot definitively be associated with one of the first object and a second object also moving along the first travel area;
identifying, based on continued tracking of both the first object and the second object that the changes in subsequent RFID tag reads, that a portion of the determined path of the first object after the detection of the instance where the change in RFID tags being read could not be associated with one of the first object and the second object; and
replacing the portion of the determined path associated with the first object, with a corresponding portion of a determined path associated with the second object after the detection of the instance where the change in RFID tags being read could not be associated with one of the first object and the second object.

18. The method of claim 10, further comprising:
identifying that the first object is a threshold distance from the first travel area; and
controlling a lighting system and at least one RFID tag reader corresponding to the first travel area based on the tracked location of the first object.
